(19) United States
(12) Patent Application Publication
(10) Pub. No.: US 2005/0062943 A1
(43) Pub. Date: Mar. 24, 2005

(54) Projector

(76) Inventor: Huang-Chi Liu, Taipei City (TW)

Correspondence Address: SNELL & WILMER;ONE ARIZONA CENTER, 400 EAST VAN BUREN, PHOENIX, AZ, 850040001, US

(21) Appl. No.: 10/947,946

(22) Filed: Sep. 23, 2004

(30) Foreign Application Priority Data
Sep. 23, 2003 (TW) 92126188

(51) Int. Cl. G03B 21/14

(52) U.S. Cl. 353/84

(57) ABSTRACT

A color-filter belt and a projector using the same are provided. The projector includes a light source, a color-filter belt, a driving unit and a reflective image unit. A light beam, generated by the light source, is projected onto the color-filter belt. The color-filter belt filters out light of specific wavelengths to present primary colors. A driving unit drives the color-filter belt. The reflective image unit receives the filtered light from the color-filter belt and then forms an image on a screen.

### CROSS-REFERENCE TO RELATED APPLICATIONS

This application claims priority of Taiwan Patent Application Serial No. 092126188 filed on Sep. 23, 2003.

1. Field of Invention

The present invention relates to a projector having a color-filter belt.

2. Background of the Invention

A typical imaging producing system uses primary colors, e.g. red, green, and blue, to produce images. The combination of these primary colors achieves full-color visual effects.

In a sequential color system, as generally known in the art, images are generated based on a sequential color method. In short, each single red, green, or blue color in an image frame lasts 1/60 of a second according to a predetermined order. Due to the human visual perception, a viewer sees a full-color image.

In general, a projector, using the sequential color method, includes a white light source 100 and a color wheel 102. The color wheel rotates, and a white light generated by the white light source passes through the color wheel. As shown in FIG. 1, the color wheel includes a number of light filter segments 104, 106, 108 of different colors, such that the light passing through the color wheel is sequentially filtered by each segment to generate primary colors, such as red, green, and blue.

Although the prior art based on the color wheel has been generally adopted, one of problems associated with the wheel is that the limited design-choices of the drive of the color wheel greatly restrict the mechanical design of projectors. In addition, the color wheel has only limited area for three filter segments. In order to achieve minimum filtering frequency, the color wheel has to rotate at a high speed causing higher power consumption, noise, and vibrations. Furthermore, the heat caused by the incident light on the surface of the color wheel accumulates quickly because of the small areas of the filter segments. As a result, the prior art has the drawback of low durability and requiring specific materials for the filter segment to meet the heat-dissipation requirements.

### SUMMARY OF THE INVENTION

The main aspect of the present invention provides a projector having the color-filter belt. Since the moving path of color-filter belt is adjustable, it allows more flexibility in the mechanical design of the projector.

A projector includes a light source, a color-filter belt, a driving unit, and a reflective image unit. The light source generates a light beam projected into the color-filter belt in a first direction. The driving unit drives the color-filter belt to move in a second direction intersecting with the first direction. The light beam includes at least a first light with a first wavelength and a second light with a second wavelength. As the color-filter belt filters the light beam, the filtered lights selectively pass the color-filter belt to present specific colors. The reflective image unit reflects the filtered light beam from the color-filter belt to project an image on the screen.

The color-filter belt includes at least a first filter and a second filter. As the light beam is projected into the color-filter belt, the first filter allows passage of the first light and the second filter allows passage of the second light. In the embodiment, the light beam includes a red light, a green light, and a blue light. Correspondingly, the color-filter belt includes three filters, which are respectively transparent to the red light, the green light, and the blue light. As the driving unit drives the color-filter belt to move around the light source, the light beam is sequentially projected into different filters. The filtered lights are respectively the red light, the green light, and the blue light. The reflective image unit receives and modulates the filtered lights to generate an image on the screen. These three sequenced filters are provided repeatedly on the color-filter belt. In comparison to the color wheel, the whole length of color-filter belt receives and dissipates the heat caused by the incident light. Optionally, a number of fans may be provided along the moving path of the color-filter belt to enhance the cooling efficiency.

In order to match with the modulation frequency of the reflective image unit, one must vary the filtering frequency by adjusting the moving speed of the color-filter belt. Given a constant filtering frequency, a lower moving speed along with wider filters on the color-filter belt can reduce the power consumption and noise. Moreover, adjusting the color belt's moving speed also determines the brightness and saturation of the produced image. For example, the image appears brighter if a filter allowing passage of more incident light moves more slowly.

### BRIEF DESCRIPTION OF THE DRAWINGS

FIG. 1 is a diagram of a color wheel according to the prior art;

FIG. 2 is a diagram of a projector having the color-filter belt according to an embodiment of the present invention; and

FIG. 3 is a partial diagram of a color-filter belt according to an embodiment of the present invention.

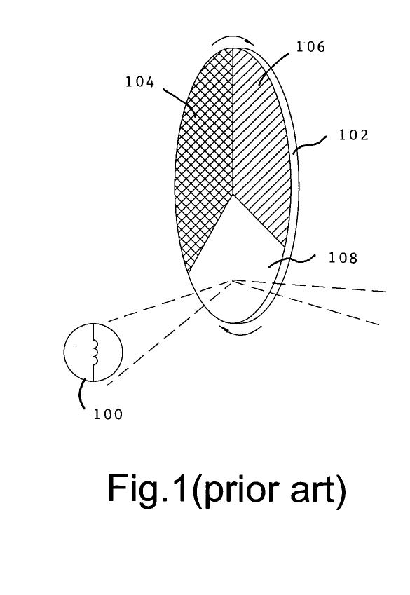

### DETAILED DESCRIPTION

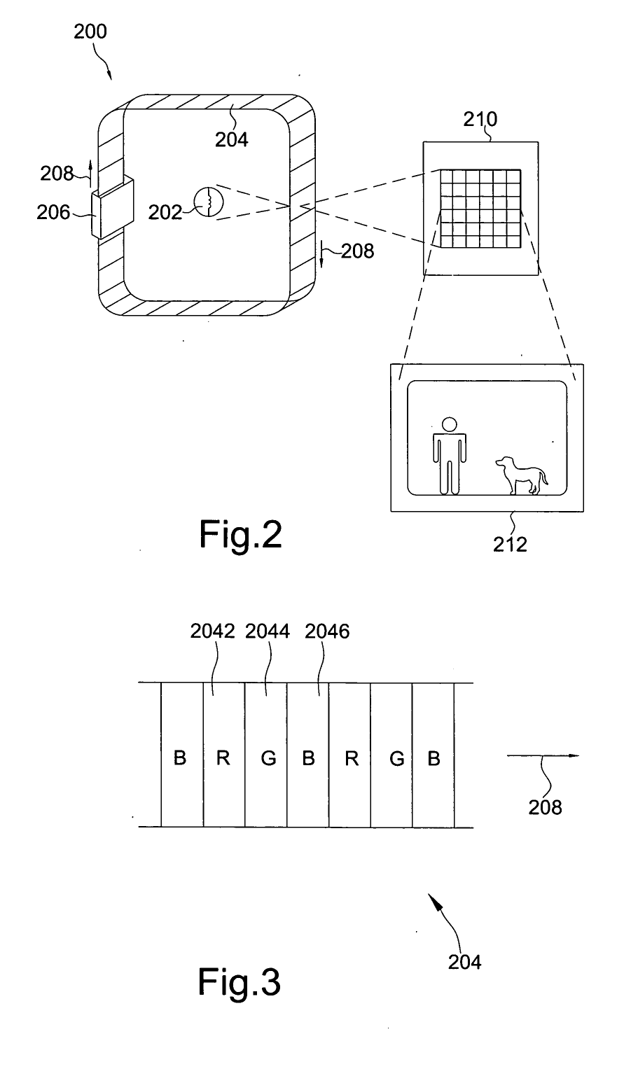

FIG. 2 is a diagram of a projector having a color-filter belt according to an embodiment of the present invention. A projector 200 includes a light source 202, a color-filter belt 204, and a driving unit 206. The light source 202 generates a light beam projected through the color-filter belt 204 in a first direction. The light beam includes at least a first light with a first wavelength and a second light with a second wavelength. In an embodiment, the light source 202 is a white light bulb, the first wavelength corresponds to a hue of red light, and the second wavelength corresponds to a hue of blue light. In another embodiment, the light beam further includes a light of a third wavelength corresponding to a hue of green light.

The driving unit 206 drives the color-filter belt 204 to move around the light source 202 to filter the light beam, wherein the color-filter belt 204 moves along a direction 208 intersecting with the first direction, and the light of different wavelengths selectively passes through the color-filter belt 204 when the light beam is incident onto the color-filter belt 204. The color-filter belt 204 may be in a circular shape. The projector 200 further includes a reflective image unit 210. The reflective image unit 210 receives and projects the filtered light from the color-filter belt 204 to form an image on a screen 212.

FIG. 3 is a partial diagram of a color-filter belt according to an embodiment of the present invention. The color-filter belt 204 includes repeatedly arranged three sequential filters, wherein a red filter(R) 2042 allows passage of the red light, a green filter(G) 2044 allows passage of the green light, and a blue filter(B) 2046 allows passage of the blue light. Alternatively, filters 2042, 2044, 2046 are bandpass filters that selectively transmit preselected bands of light frequencies respectively centering around the red, green, and blue spectrums of the light source. As the color-filter belt 204 moves along the direction 208, the light beam from the light source 202 is projected on different filters at different times, and the light of different wavelengths passes through the color-filter belt 204 at different times. The heat caused by the incident light beam is received and dissipated by all filters 2042, 2044, and 2046. The color-filter belt 204 is made of glass fiber, and filters 2042, 2044, and 2046 are films coated on the color-filter belt 204. One could appreciate that the design of FIG. 2 allows more flexible designs for other mechanical parts of a projector.

The driving unit 206 is a motor for driving the color-filter belt 204. In order to match with the modulation frequency of the reflective image unit 210, one must vary the filtering frequency by adjusting the moving speed of color-filter belt 204. Given a constant filtering frequency, a lower moving speed along with a wider filter on the color-filter belt 204 can lower power consumption and noise.

The reflective image unit 210 has a digital micromirror device (DMD), which typically includes hundreds or thousands of micromirrors. Each micromirror corresponds to a pixel on the image. When the color-filter belt 204 filters the light of different wavelengths at a given filtering frequency, the DMD 210 receives and modulates the light at a modulating frequency corresponding to the given filtering frequency. Pixels of different colors are combined and displayed on the screen 212 to become a full-color image.

While this invention has been described with reference to the illustrative embodiments, these descriptions should not be construed in a limiting sense. Various modifications of the illustrative embodiments, as well as other embodiments of the invention, will be apparent upon reference to these descriptions. It is therefore contemplated that the appended claims will cover any such modifications or embodiments as falling within the true scope of the invention and its legal equivalents.

1. A projector, comprising:
a light source for generating a light beam, said light beam comprising a first light with a first wavelength and a second light with a second wavelength;
a color-filter belt comprising a first filter and a second filter, as said light beam is projected into said color-filter belt in a first direction, said first filter allowing passage of said first light, said second filter allowing passage of said second light; and
a driving unit for driving said color-filter belt moving in a second direction intersecting with said first direction, wherein said first light and said second light selectively pass said color-filter belt when said light beam is incident onto said color-filter belt.

2. The projector of claim 1, wherein said first light and said second light periodically pass said color-filter belt.

3. The projector of claim 1, wherein said color-filter belt is in a circular shape.

4. The projector of claim 3, wherein said color-filter belt moves around said light source.

5. The projector of claim 1, wherein said light source comprises a bulb.

6. The projector of claim 1, wherein said first wavelength corresponds to a hue of red light.

7. The projector of claim 1, wherein said first wavelength corresponds to a hue of blue light.

8. The projector of claim 1, further comprising a reflective image unit,
wherein said first light and said second light are selectively transmitted through said color-filter belt and projected on said reflective image unit, said reflective image unit reflecting said first light and said second light to form an image.

9. The projector of claim 1, further comprising a reflective image unit,
wherein said first light and said second light are selectively projected through said color-filter belt and said reflective image unit to form an image.

10. The projector of claim 8, wherein said reflective image unit comprises a digital micromirror device (DMD).

11. A projector, comprising:
a light source for generating a light beam, said light beam comprising a first light with a first wavelength and a second light with a second wavelength;
a color-filter belt being in a circular shape, comprising a first filter and a second filter, as said light beam is projected into said color-filter belt in a first direction, said first filter allowing passage of said first light, said second filter allowing passage of said second light;
a driving unit for driving said color-filter belt moving in a second direction intersecting with said first direction, wherein said first light and said second light selectively pass said color-filter belt when said light beam is incident onto said color-filter belt, and
a reflective image unit;
wherein said first light and said second light are selectively transmitted through said color-filter belt and projected on said reflective image unit, and said reflective image unit reflecting said first light and said second light to form an image.

12. The projector of claim 11, wherein said first light and said second light periodically pass said color-filter belt.

13. The projector of claim 11, wherein said first wavelength corresponds to a hue of red light.

14. The projector of claim 11, wherein said first wavelength corresponds to a hue of blue light.

15. The projector of claim 11, wherein said reflective image unit comprises a digital micromirror device (DMD).
